(19) United States
(12) Patent Application Publication
(10) Pub. No.: US 2012/0042302 A1
(43) Pub. Date: Feb. 16, 2012

(54) SELECTIVE REGRESSION TESTING

(76) Inventors: Bhava Sikandar, Bangalore (IN); Jayasankar Nallasamy, Bangalore (IN); Srinivasan Desikan, Bangalore (IN); Jonathan M. Sauer, Cupertino, CA (US)

(21) Appl. No.: 12/857,297

(22) Filed: Aug. 16, 2010

(51) Int. Cl. G06F 9/44

(52) U.S. Cl. 717/125; 717/126

(57) ABSTRACT

The present disclosure includes systems and methods for a selective regression testing. One method for selective regression testing includes grouping a number of test cases into a number of groups, analyzing a modification that is to be accomplished on a computing system to determine a level of risk of the modification to the computing system, applying one or more rules to determine which groups of test cases to apply to test the modification based upon the determined level of risk, and selecting one or more of the groups of test cases based upon the application of the one or more rules.

### FIELD OF THE DISCLOSURE

The present disclosure relates to the field of testing. In particular, the present disclosure relates to selection of test cases for regression testing.

### BACKGROUND

Many of the quality issues in software and computing device products arise out of modifications, such as updates and modifications and their side effects. Frequent releases and continuous regression testing are utilized to implement modifications, such as defect fixes, because these processes enable the release of stable software with the modifications implemented therein and provided to customers. Defects appearing after a modification has occurred and/or the quality of the regressions used are two issues that often present themselves in incremental releases of computing systems and software, and for regression testing applications.

### BRIEF DESCRIPTION OF THE DRAWINGS

FIG. 1,illustrates a computing system in accordance with an example of the present disclosure.

FIG. 2 provides a diagram illustrating a method in accordance with an example of the present disclosure.

FIG. 3 provides an example of a regression methodology that can be used in an example of the present disclosure.

FIG. 4 illustrates an example of a test case selection and/or removal methodology that can be used in example of the present disclosure.

FIG. 5 provides a diagram illustrating another method example according to the present disclosure.

### DETAILED DESCRIPTION

The present disclosure includes systems and methods for selective regression testing. For example, one method for selective regression testing includes grouping a number of test cases into a number of groups, analyzing a modification that is to be accomplished on a computing system to determine a level of risk of the modification to the computing system, applying one or more rules to determine which groups of test cases to apply to test the modification based upon the determined level of risk, and selecting one or more of the groups of test cases based upon the application of the one or more rules.

Such methods and systems can be beneficial, for example, because with relatively low effort, test professionals may be able to reduce the amount of resources expended, particularly in the middle of a release cycle or a customer patch release, among other benefits. Examples of the present disclosure can provide test management tools that utilize test related stored data (such as in a database or repository) for selecting a specialized set of test cases for use in a regression testing process.

In some applications, regression testing can be defined as selective retesting of a system or component to verify that modifications of the system or component have not caused unintended effects and that the system or component still complies with its specified requirements. But in practice, testing professionals typically utilize a constant set of test cases during their testing procedures. In many situations, however, a number of the test cases which are part of the constant regression set need not be executed, as they could, for example, be there for historical reasons and may not be relevant to the current modification and/or side effects, for instance. Inclusion of such test cases increases the test cycle effort resulting in higher cost to the organization.

Customer specific modifications (e.g., software patches) also are released on top of major and minor versions of software. Apart from defect fixes, any new functionality introduced in the product may pass through a regression test cycle to ensure there are no side effects and/or that older functionalities continue to work as before. Releasing new features on an existing piece of software by nature increases the number of test cases that may be utilized to ensure continued quality as the software is changed and/or increase the number of features that should be tested. Although some embodiments will be described herein that use defect fixes, it should be understood by the reader, that embodiments of the present disclosure can be utilized with modifications that are made to a computing system or device that provide new features or changes as described herein and not just defect fixes.

Test engineers also utilize regression testing. Additionally, regression tests can be executed multiple times in a release as research and development teams typically phase their development cycles and as such the testing cycle may be repeated for each development cycle or multiple times over the overall period of development.

Regression test cycles for products typically evolve over a period of time as they are reused and updated as newer versions of the software program are implemented and, as a result; test cases typically grow in large number over the life of the products, resulting in more time to execute the complete regression test cycle.

During a typical regression test execution cycle, potentially large numbers of test cases are executed even though they may not identify any defects. These test cases may, for example, be executed due to a historical or legacy reason. Such practices typically increase the cost, risk, and/or time to evaluate a release.

Moreover, regression professionals do not utilize the information that comes from a build report (e.g., information regarding a set of defects fixed) or information that comes from test management tools (e.g., information regarding how many times a particular test case has been passed, etc.) for selecting a correct set of test cases for a regression cycle. This may not be done because the professional may not know the purpose of the regression testing, does not leverage a standard regression methodology, or the professional does not have a test case management tool for regression testing.

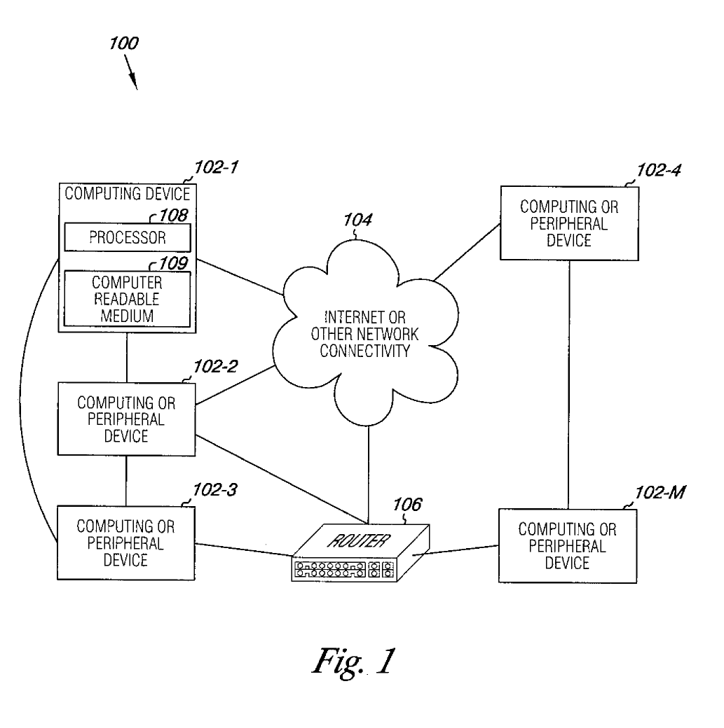

FIG. 1 illustrates a computing system example according to the present disclosure. The example of FIG. 1 provides an example of a network that can be utilized with examples of the present disclosure, however, any number of computing devices and/or peripheral devices can be arranged in any manner wherein the examples can be utilized.

In the example of FIG. 1, the system 100 includes a number of interconnected devices 102-1, 102-2, 102-3, 102-4, and 102-M. As used herein the M and N denote that there can be any number of the described item.

The devices can be interconnected, either wired or wirelessly, directly, as is illustrated by devices 102-4 and 102-M, for example; or can be connected indirectly, for example, as through a router 106 and/or a network 104, such as the Internet 104, among other types of network connectivity that could be utilized to connect multiple computing and/or peripheral devices together in examples of the present disclosure.

Additionally, as used herein a computing device can have a processor therein for executing instructions thereon. Examples of computing devices include, but are not limited to, servers, desktop computers, laptops, notebook computers, and handheld computing devices.

A peripheral device may have a processor or other logic, but communicate with a computing device to provide additional functionality. Examples of peripheral devices include, but are not limited to, printers, scanners, fax devices, memory devices, devices that provide communication functionality to the computing device, and other such device types.

Device 102-1 includes a processor 108 and a computer readable storage medium 109 for storing processor executable instructions and/or data thereon. It should be understood that instructions may reside on one device and can be executed on another device of the network.

The device 102-1 can contain executable instructions to provide a user interface that can be accessed by a user via a display component of the device. The device can also include executable instructions to provide, for example, a quality management tool, a test management tool, a defect management tool, and/or a database having a set of historical defect data and/or a set of historical test case data for use by a user and accessible via the user interface.

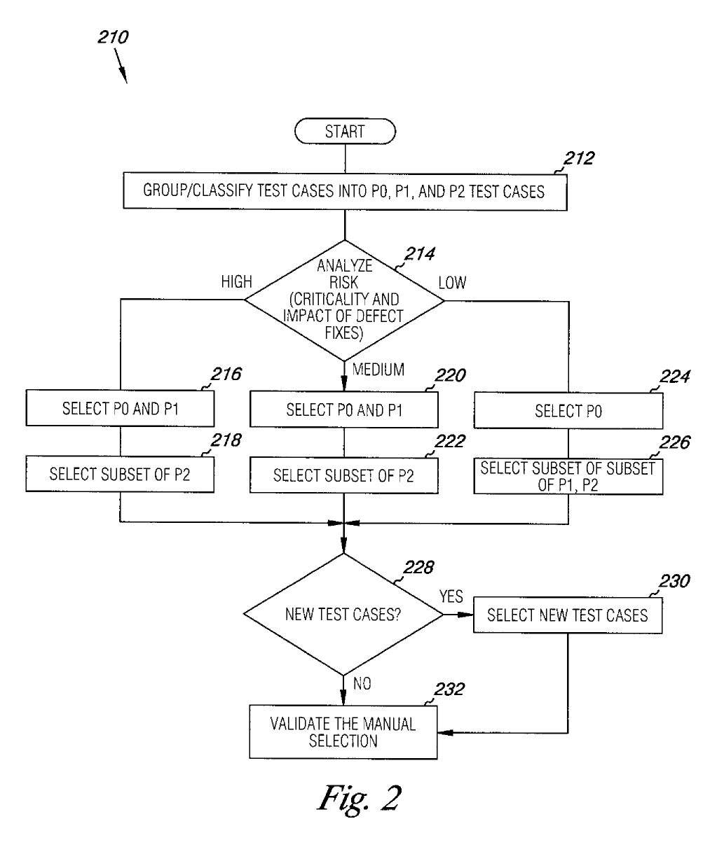

FIG. 2 provides a diagram illustrating a method example according to the present disclosure. In the example of FIG. 2, the method 210 includes grouping test cases of a system or component (e.g., devices 102- to 102-M shown in FIG. 1 including, hardware, software and firmware) into one or more groups (e.g., P0, P1, and P2 test case groups) at 212. Grouping the test cases into one or more groups can be accomplished, for example, by classifying the test cases into priorities based on, for instance, customer value and/or project value.

In some such examples, the customer value can be assigned to a test case based, for example, on whether the fixed defect will be highly visible, whether the area in the code where the defect exists is used by one or more customers, whether the area in the code where the defect exists is in an area that frequent defects are found by customers, and/or whether the area in the code where the defect exists is provides one or more core features that are used to interact with customers. A project value can, for example, be assigned to a test case based on whether the test case is for a core functionality of the computing device or system, is used to validate underlying infrastructure and/or design of the computing device or system, is for a module or piece of software code that has had a certain threshold number of recent modifications (e.g., within a time period), and/or is in an area of the product that is highly visible to customers.

The groups that are created can be any suitable grouping type for grouping test cases to be able to reduce the number of cases utilized, for example, for regression testing. In the example of FIG. 2, P0 represents test cases that check the basic functionality of the product and they provide very high customer value. P1 test cases represent test cases that provide moderate value to the customer and/or check the extended functionality of the product. P2 test cases represent those test cases that provide low customer value and/or test the features that are low on project value.

In the example of FIG. 2, the method also includes analyzing risk at 214. For example, by fixing a minor or cosmetic defect in a computing device or system, a fix can break an element of the basic functionality of the device or system, creating a large impact to the customer.

With regard to situations such as the above example, it is useful to analyze how well a defect is fixed in the code and/or what kind of impact it can cause to the customer. Hence, it is useful to analyze the criticality of the modification and impact of those one or more modifications to the customers for each build or test cycle. Once the analysis is over criticality/impact fields in a test management tool (e.g., a software application stored in memory on a computer readable medium and usable by a user via a user interface such as a computing device display) can be filled in, as High, Medium, or Low for each regression test cycle.

In some examples, there can be situations where the test professional may not have complete details about coming into a regression cycle and, therefore, may not be able to judge the criticality and/or impact of the modification. In such situations, the regression methodology of the present disclosure can be applied by an alternative method, for example, by mapping modifications with a feature set. In such instances, a “criticality of defect fix” element can be mapped with a “criticality of impacted features” element and an “impact due to defect fixes” element can replaced by an “impact of those feature fixes to customers” element.

In the example of FIG. 2, the method includes a selection of the test cases methodology. This includes a number of different selection possibilities 216, 218, 220, 222, 224, and 226 based upon a determination of a risk value (e.g., high risk goes through 216 and 218, medium risk through 220 and 222, and low risk go through 224, and 226).

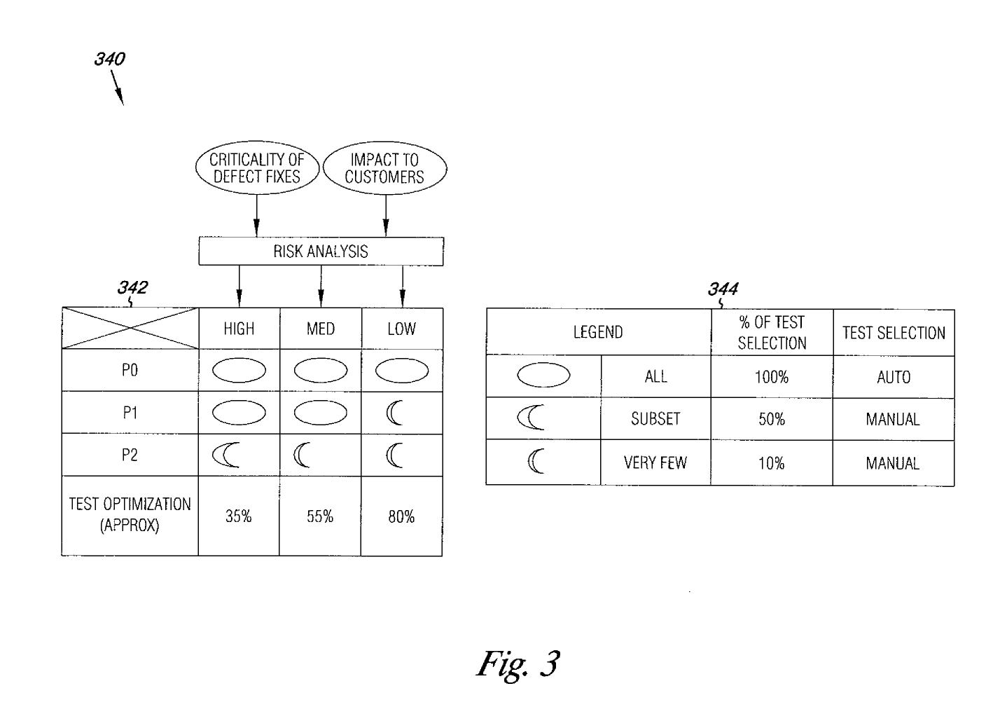

In some examples, the selection of groups (e.g., P0, P1, and/or P2) of test cases is manually accomplished and in other examples, the selection can be done at least partially automatically (e.g., through use of a test management tool having executable instructions for making selections based upon the process discussed above). In such examples, a test management tool can auto select test cases, for example, based on a method such as that described in FIG. 3. The tool can, for example, create an instance of the test cases that are to be executed for current regression cycle.

Each test case can include a number of pieces of information. For example, a test case can have a field name such as: Test name, Test type, Test ID, etc.

A test management tool can, for example, use a field name, such as “Priority”, to select test cases depending on their importance to a product and/or customer. For example, if a criticality of the modification and an impact to the customers are both high for a particular product build, the test management tool can automatically select “All” P0 and P1 test cases to be executed for regression cycle based upon the rules illustrated in FIG. 3. In some examples, the selection can be accomplished manually via a user interface of a computing device.

In some examples, after the test cases are selected based upon their grouping and (e.g., manually or automatically selected via the tool as per a regression methodology such as the methodology illustrated in FIG. 3), a user can be prompted to select one or more additional test cases, for example, based on their analysis of criticality and/or impact. In order to accomplish this, the user can, for example, analyze what areas changed with the modification and/or how the modification can impact the customer and, accordingly, select a subgroup (e.g., one or more test cases from the non-selected test cases or a subgroup of a group of test cases) of test cases to be run.

Such examples can be beneficial because, for example, an effective regression testing can utilize both group selection based upon rules analyzed by a computing device, and a tester professional's intuitiveness, which may be different from the results of the computing device based analysis. For example, if criticality and/or impact of a modification for a particular build is high, the selection by the test management tool may select all P0 and P1 test cases according to the rules applied. The user may be prompted to select from the P2 test cases as described in FIGS. 2 at 218, 222, and 226 (select from P1 and P2 for element 226).

In some examples, the user interface can list all of the test cases sorted and that are not selected previously, for example, by priority along with other information, such as: test case name, test area, complexity, etc. This information may be beneficial, for example, because it would help the end user to select a correct (in the view of the user) set of test cases from each of the categories. For instance, test cases most relevant to a modification area can be automatically identified using an identifier to mark each one, such as a marked box, to logically help the user to select the desired cases based upon review of those items that are identified with marked boxes.

In various examples, the test cases that are most relevant can be judged by the tool, by having a mapping between, for example, a customer reported defect ID with test case ID that was added to verify a reported defect. Test management tools, can provide both a modification database and test case database, in some examples, these suggestions can be implemented.

This process can be automated in some examples. This can be beneficial because it allows for in close-loop-analysis of defects that are reported by customers and how they can be automatically verified during regression testing using this methodology.

In some examples, the computing device and/or system can be checked to see if any new test cases are available, such as at 228 of FIG. 2. If there are new test cases, then they can be added to the test cases already selected from groups, subgroups, and individually at 230.

In various examples, validation of the selections can be performed as is illustrated at 232 of FIG. 2. In order to accomplish this, the selection can be validated, for example, with heuristic rules. The test management tool can also be utilized in validating any manual selections by heuristic rules. Some of the proposed rules applied in the illustration, are described in the example illustrated in FIG. 3.

These rules can be beneficial because they may help in validating some of the test cases that are inadvertently left out by the user and/or some test cases which could have been wrongly selected. For example, if a test case has failed 10 times in the past, and there are no modifications to address this defect in the current product build, then there may be no reason to execute that particular test case again. This is because of the conviction that this particular test case is expected to fail 11th time too.

In some examples, a test management database can be utilized to keep a test history for every time a test case is executed. This can be beneficial because it can be easier for an automated methodology to look at a history of a test case's results and make intelligent removal selection by a tool as it is difficult for a test professional to remember the history of a test case's results and do the analysis and/or add or remove selection as described above.

Once the test cases are executed, the next step is to execute those selected regression test cases and produce reports and/or metrics. Any suitable types of metrics can be provided in the various examples. One type of metric that could be provided is a comparative look at different regression test cycles (e.g., progress and status) can be of use.

FIG. 3 provides an example of a regression methodology that can be used in examples of the present disclosure. In FIG. 3, the methodology 340 provides a matrix 342 wherein the level of risk is analyzed based upon the criticality of the modification and/or the impact on the customer. In the example shown, the methodology 340 has three risk levels (e.g., high, medium, and low). These risk levels can, for example, be defined by thresholds separating the risk levels and then the risk level can be calculated by executable instructions stored within a computing device based upon criticality of the modification information and/or the impact on the customer information provided, for example, by user input of from data in a database provided on a computing device.

The matrix 342 then provides what the selection of groups of test cases will be based upon which risk level the regression process falls into. The legend 344 provides information as to what the symbols in the matrix mean and provides information regarding whether the computing system will automatically select the test cases or whether the user will manually select some or all of the cases to be selected. The methodology 340 of FIG. 3 is an example of a suitable methodology that could be used.

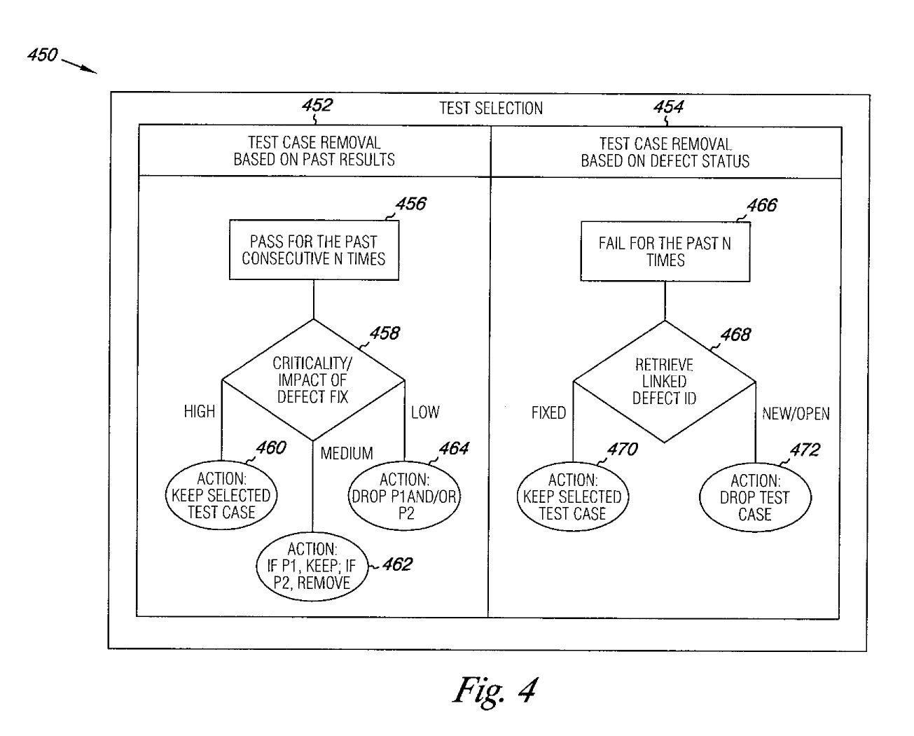

FIG. 4 illustrates an example of a test case selection and/or removal methodology that can be used in examples of the present disclosure. In the example of FIG. 4, the methodology 450 includes two types of removal processes; namely, removal of one or more selected test cases based upon one or more past results of the test case 452 and removal based upon defect status 454.

The removal of one or more selected test cases based upon one or more past results of the test case can, for example, be accomplished by analyzing information selected from the group including: a number of times a particular test case has failed and whether any modifications to address a particular defect are provided in a set of executable instructions being tested.

In the example of FIG. 4, the removal based upon past results 452 includes review to ascertain the number of consecutive pass results have been returned when the test case was utilized (N results) at 456. Also evaluated are the criticality and/or the impact at 458. In the example of FIG. 4, once this analysis is complete a decision regarding whether or not to remove the test case is made at 460, 462, or 464.

In the example of FIG. 4, the removal based upon defect status 454 includes review to ascertain the number of fail results have been returned when the test case was utilized (N results) at 466. In this example a defect identifier for the test case is retrieved at 468. The status of the defect is then ascertained and a decision as to whether or not to remove the test case is made at 470 and 472.

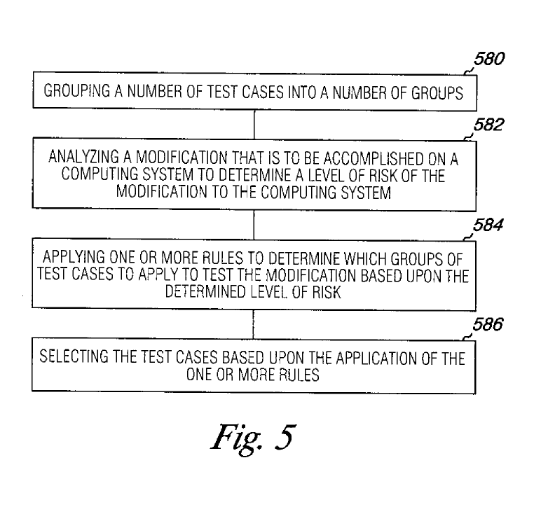

FIG. 5 provides a diagram illustrating a method example according to the present disclosure. In the example of FIG. 5, the method for selective regression testing includes grouping a number of test cases into a number of groups at 580.

The grouping a number of test cases into a number of groups can be accomplished by prioritizing the test cases based upon a customer value and a project value. The prioritizing the test cases based upon a customer value and a project value can, for example, be provided by prioritizing the test cases based upon one or more criteria selected from the group including: checking basic functionality, checking extended functionality, checking features that provide high project value, checking features that provide moderate project value, checking features that provide low project value, among other suitable criteria.

In some examples, the computing device or system can include defect identifier information and test case identifier information that can be linked to each other as discussed above with respect to FIG. 4. This information can then be used to group or select test cases.

The example of FIG. 5 also includes analyzing a modification that is to be accomplished on a computing system to determine a level of risk of the modification to the computing system at 582.

In some examples, analyzing a modification that is to be accomplished on a computing system to determine a level of risk of the modification to the computing system is accomplished based on determining a criticality of the modification on the computing system and applying a rule based upon the determined criticality. In various examples, analyzing a modification that is to be accomplished on a computing system to determine a level of risk of the modification to the computing system is accomplished based on determining an impact of the fix on the computing system to one or more customers and applying a rule based upon the determined impact. In some examples, both techniques are utilized.

Analyzing a modification that is to be accomplished on a computing system to determine a level of risk of the modification to the computing system can, for example, be accomplished based on determining a criticality of the modification on the computing system, determining an impact of the modification on the computing system to one or more customers, and applying a rule based upon evaluating both the determined criticality and impact.

Applying one or more rules to determine which groups of test cases to apply to test the modification based upon the determined level of risk is provided in the example of FIG. 5 at 584. Some examples utilize multiple levels of risk thresholds to determine which groups of test cases to apply to test the fix based upon the determined level of risk as discussed with respect to FIG. 2, wherein there are three risk levels and each level has at least threshold separating it from another threshold.

The example also includes selecting the test cases based upon the application of the one or more rules at 586. In some examples, selecting the test cases based upon the application of the one or more rules is performed automatically by executable instructions. In some examples, the computing system can include executable instructions to provide a user with a user interface to manually determine whether to select one or more of the new test cases to be added to the test cases selected based upon the application of the one or more rules. In some examples, selecting the test cases based upon the application of the one or more rules is performed automatically by executable instructions and wherein the computing system includes executable instructions to provide a user with a user interface to manually determine whether to add one or more non-selected test cases to the test cases selected based upon the application of the one or more rules as discussed above with respect to FIGS. 1 and 2.

In some examples, the method can include determining whether any new test cases are available for the modification and determining whether to select one or more of the new test cases to be added to the test cases selected based upon the application of the one or more rules. Determining whether to add one or more non-selected test cases to the test cases selected based upon the application of the one or more rules, can also be provided.

In various examples, a method can include applying one or more rules to determine which groups of test cases to apply to test the modification based upon one or more criteria selected from the group including test result history, priority of test cases, and associated defects.

Not all of the components and/or communication channels illustrated in the figures have to be used to practice the system and method of the present disclosure, and variations in the arrangement, type, and quantities of the components may be made without departing from the scope of the system and method of the present disclosure. Network components can include personal computers, laptop computers, mobile devices, cellular telephones, personal digital assistants, or the like.

A computing device can include one or more processors, and non-transitory computer-readable media (e.g., memory) for storing instructions executable by the one or more processors and data therein.

A computing device can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement. The control circuitry can have a structure that provides a given functionality, and/or execute computer-readable instructions that are stored on an internal or external non-transitory computer-readable medium.

The non-transitory computer-readable media can be programmed with instructions such as an operating system for controlling the operation of a computing device and/or applications such as the test management tool. Computing devices may also include an internal or external database, or other archive medium for storing, retrieving, organizing, and otherwise managing data sources and/or the functional logic of the computing device or system.

The non-transitory computer-readable medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information.

Examples of non-volatile memory can include solid state media such as flash memory, EEPROM, phase change random access memory (PCRAM), among others. The non-transitory computer-readable medium can include optical discs, digital video discs (DVD), high definition digital versatile discs (HD DVD), compact discs (CD), laser discs, and magnetic media such as. tape drives, floppy discs, and hard drives, solid state media such as flash memory, EEPROM, phase change random access memory (PCRAM), as well as other types of machine-readable media.

Machine readable and executable instructions and/or logic, which are operable to perform the methods described in connection with FIGS. 2 and 5, can be present in whole or in part in the examples of other figures. Examples, however, are not limited to the particular examples given herein.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure.

It is to be understood that the above description has been made in an illustrative fashion, and not a restrictive one. Combination of the above examples, and other examples not specifically described herein will be apparent to those of skill in the art upon reviewing the above description.

The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Various examples of the system and method for collaborative information services have been described in detail with reference to the drawings, where like reference numerals represent like parts and assemblies throughout the several views. Reference to various examples does not limit the scope of the system and method for displaying advertisements, which is limited just by the scope of the claims attached hereto. Additionally, any examples set forth in this specification are not intended to be limiting and merely set forth some of the many possible examples for the claimed system and method for collaborative information services.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an example,” as used herein does not necessarily refer to the same example, although it may.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim.

Rather, as the following claims reflect, inventive subject matter lies in less than all features of a single disclosed example. Thus, the following claims are hereby incorporated into the Detailed Description, with each claim standing on its own as a separate example.

What is claimed:

1. A method for selective regression testing, comprising:
grouping a number of test cases into a number of groups;
analyzing a modification that is to be accomplished on a computing system to determine a level of risk of the modification to the computing system;
applying one or more rules to determine which groups of test cases to apply to test the modification based upon the determined level of risk; and
selecting one or more of the groups of test cases based upon the application of the one or more rules.

2. The method of claim 1, further comprising:
determining whether any new test cases are available for the modification; and
determining whether to select one or more of the new test cases to be added to the test cases selected based upon the application of the one or more rules.

3. The method of claim 2, wherein the method includes determining whether to select one or more of the new test cases automatically by executable instructions.

4. The method of claim 2, wherein the computing system includes executable instructions to provide a user with a user interface to manually determine whether to select one or more of the new test cases to be added to the test cases selected based upon the application of the one or more rules.

5. The method of claim 1, further comprising:
determining whether to add one or more non-selected test cases to the test cases selected based upon the application of the one or more rules.

6. The method of claim 5, wherein selecting the test cases based upon the application of the one or more rules is performed automatically by executable instructions and wherein the computing system includes executable instructions to provide a user with a user interface to manually determine whether to add one or more non-selected test cases to the test cases selected based upon the application of the one or more rules.

7. The method of claim 1, wherein analyzing a modification that is to be accomplished on a computing system to determine a level of risk of the modification to the computing system includes determining a criticality of the modification on the computing system and applying a rule based upon the determined criticality.

8. The method of claim 1, wherein analyzing a modification that is to be accomplished on a computing system to determine a level of risk of the modification to the computing system is accomplished based on determining an impact of the modification on the computing system to one or more customers and applying a rule based upon the determined impact.

9. The method of claim 1, wherein analyzing a modification that is to be accomplished on a computing system to determine a level of risk of the modification to the computing system utilizes multiple level of risk thresholds to determine which groups of test cases to apply to test the modification based upon the determined level of risk.

10. The method of claim 1, wherein applying one or more rules to determine which groups of test cases to apply to test the modification based upon the determined level of risk utilizes multiple level of risk thresholds to determine which groups of test cases to apply to test the modification based upon the determined level of risk.

11. The method of claim 1, further comprising:
applying one or more rules to determine which groups of test cases to apply to test the modification based upon one or more criteria selected from the group including test result history, priority of test cases, and associated defects.

12. The method of claim 1, wherein grouping a number of test cases into a number of groups includes prioritizing the test cases based upon a customer value and a project value.

13. The method of claim 12, wherein prioritizing the test cases based upon a customer value and a project value includes prioritizing based upon one or more criteria selected from the group including: checking basic functionality, checking extended functionality, checking features that provide high project value, checking features that provide moderate project value, checking features that provide low project value.

14. The method of claim 1, wherein analyzing a modification that is to be accomplished on a computing system to determine a level of risk of the modification to the computing system includes determining a criticality of the modification on the computing system, determining an impact of the modification on the computing system to one or more customers and applying a rule based upon evaluating both the determined criticality and impact.

15. A non-transitory computer-readable medium having computer-readable instructions stored thereon that, if executed by one or more processors, cause the one or more processors to:
apply one or more rules to test cases that have been classified and a risk of modification has been analyzed to determine which groups of test cases to apply to test a modification based upon the determined level of risk; and
automatically select the test cases based upon the application of the one or more rules.

16. The non-transitory computer-readable medium of claim 15, further including computer-readable instructions stored thereon that are executable by the processor to:
link a defect identifier with a test case identifier that can be used to group or automatically select test cases for regression testing.

17. A system for a selective regression testing, comprising:
one or more computing devices including a processor and memory, wherein the memory contains computing device readable instructions executable by the processor to:
apply one or more rules to test cases that have been classified and a risk of modification has been analyzed to determine which groups of test cases to apply to test a modification based upon the determined level of risk; and
select the test cases based upon the application of the one or more rules.

18. The system of claim 17, further including instructions executable by the processor to:
remove one or more selected test cases based upon one or more past results of the test case.

19. The system of claim 18, wherein removing one or more selected test cases based upon one or more past results of the test case includes analyzing information selected from the group including: a number of times a particular test case has failed and whether any modification to address a particular defect are provided in a set of executable instructions being tested.
